(19) United States
(12) Patent Application Publication
(10) Pub. No.: US 2007/0089128 A1
(43) Pub. Date: Apr. 19, 2007

(54) METHOD AND SYSTEM FOR PRODUCING PROGRAM-INTEGRATED ADVERTISEMENTS

(75) Inventors: John L. Makowski, Jr., Ellicott City, MD (US); Stephen C. Intlekofer, Severna Park, MD (US)

Correspondence Address: FISH & RICHARDSON P.C., P.O. BOX 1022, MINNEAPOLIS, MN, 55440-1022, US

(73) Assignee: Denizen LLC, a Delaware corporation

(21) Appl. No.: 11/611,606

(22) Filed: Dec. 15, 2006

Related U.S. Application Data
(63) Continuation of application No. 10/968,567, filed on Oct. 19, 2004.
Application No. 10/968,567 is a continuation-in-part of application No. 09/989,276, filed on Nov. 20, 2001, now Pat. No. 6,859,936.
(60) Provisional application No. 60/290,582, filed on May 11, 2001.

(51) Int. Cl. H04N 7/025; H04N 7/10; H04N 7/173

(52) U.S. Cl. 725/34; 725/32; 725/134; 725/35

(57) ABSTRACT

A method and system for incorporating thematic content from a particular program into product or service advertisements uses program-advancing elements of a program in an advertisement in order to entice viewers to view the advertisements. Increased viewership of advertisements can result in increased revenue generated from advertisements that may be realized by programs, television and movie producers, networks, publishers and advertisers.

### CROSS-REFERENCE TO RELATED APPLICATIONS

This application is a continuation in part of U.S. application Ser. No. 09/989,276, filed Nov. 20, 2001, which claims the benefit of U.S. Provisional Application No. 60/290,582; filed May 11, 2001, the entire disclosures of which are incorporated herein by reference.

### FIELD OF THE INVENTION

The present invention is directed to specialized advertising. More particularly, the present invention relates to a method and system for incorporating thematic content from a program or other work into product or service advertisements.

### BACKGROUND OF THE INVENTION

Television networks sell advertising during television programs and generally receive revenue for use of the commercial airtime in proportion to the program's viewership, i.e., ratings. As such, networks face the problem of viewers not watching the commercials in between segments of the television program. This is especially troublesome with the prevalent use of remote controls allowing a viewer to change channels without moving and the use of videocassette recorders that allow viewers to watch programs at different times than they are shown on the networks (i.e., time shifting). In addition, TiVo®-type devices which allow time shifting of programs on a real-time basis can diminish the amount of commercials watched by viewers.

Producers of print media also sell advertising that appears in publications. Readers of the publications do not always read the advertisements. Often times, the reader ignores or skips the advertisements.

Advertisers have tried to hype their commercials, for example, for new product releases, before they are going to be shown during a television event like the Super Bowl, the Oscars, etc. Also, advertisers have utilized actors from television commercials (e.g., Jerry Seinfeld of the “Seinfeld” program in American Express® commercials, Jason Alexander in Rold Gold® (a registered trademark of Frito-Lay) pretzel commercials, or the Costanzas from the “Seinfeld” program acting in character in an MCI commercial, but never has an actor appeared in character in an advertisement in a context through which the thematic content of a program is advanced. In the old days of television, an actor might even break away from a television program to advertise a product (e.g., the program “I Love Lucy®” with toothpaste), but these types of commercial breaks are no longer used. A need now exists for a method of enticing viewers to remain tuned not only to a specific program but also throughout the entirety of each of that program's commercial breaks and a need also exists for a method of enticing viewers to read or view the advertisements contained in printed publications. This will provide monetary benefit to networks and publishers and a consistent viewership for advertisers.

The viewer tendency of wandering off from his/her original program of interest during a commercial break and never returning has become a major concern of television networks. The sheer volume of programs to choose from on a cable or satellite system has caused viewers to end up only watching about a fraction of, on average, three to four different shows, switching to a new program at the onset of a commercial break.

Viewers' ability to ignore commercials has caused television to move closer to nonstop advertising through product placements in shows, onscreen crawls, and the use of promotional logos in the middle of programs. Even informational content can serve as an advertisement, such as ESPN's “bottom line” on-screen display of sports scores and information which also includes advertising for programs, related channels and products (e.g., one such advertisement urges people to buy their NFL Draft gear from a web site).

The cable channel, Oxygen™, has taken that bottom-line approach a step further by positioning an information line at the bottom of programming and commercials, supplementing advertisements with an additional slogan line, the products telephone number, or its Internet address.

In addition, during a prime-time program, NBC has inserted a graphic promoting its new series “Weakest Link.” Also, MTV™ runs countdowns to a big event during other programs, such as its annual music awards. Further, during baseball telecasts, the picture is reduced so that half of the screen can be used to remind viewers that there are tickets available for upcoming games.

Another approach has put products in program names, such as “Kraft Premier Movie” telecast of a new version of “Murder on the Orient Express.” More subtle tactics include the use of sponsors' products within programs, such as when a player on “Survivor: The Australian Outback” pined for Doritos®, or the department store Target sponsoring items distributed to the contestants.

There have also been similar corporate tie-ins to programs, such as Disney World becoming a location for episodes of shows on Disney-owned ABC.

As indicated above, several factors have caused television to create the constant commercial. One of the reasons for the introduction of such factors is that the load of traditional advertisements has steadily grown over the years. While the amount varies from show-to-show, generally 25 to 30 percent of commercial-TV viewing is for advertising.

The constant logos for stations and networks in the corner of TV screens tell zap-happy viewers where they are to help Nielsen headcounters track ratings. On-screen weather maps and news crawls that do not completely interrupt the programs are a way to keep viewers informed without waiting for a commercial break when they may be channel hopping. Also, the maps and crawls serve a secondary purpose of promoting an upcoming newscast.

Various technology has been used to ease the insertion of advertisements in between program segments, such as using automatic computer control into cable or satellite broadcasts. Also, advertisements have been customized for the individual viewer. In addition, techniques such as “road block advertising” have been used to run the same advertisement on different networks simultaneously. Further, satellite viewers may receive broadcast advertisements from the local areas, rather than nationwide advertisements by a system that selectively transmits such advertisements to satellite viewers in certain areas.

Viewers' ability to ignore advertisements may be a reason for the sexier images now found in print media. However, viewers may be more likely to remember what the model in an advertisement looked like than the product being advertised.

Many of the techniques of inserting advertising or logos into programs prove offensive to viewers which may turn them off to programs and reduce viewership and corresponding advertising revenue. Accordingly, there is a need for a method and system to ensure that program viewers will view the programs and corresponding advertisements.

### SUMMARY OF THE INVENTION

The present invention comprises a method and system for incorporating thematic content from a particular program into product or service advertisements. The present invention also comprises a method and system for increasing the viewership of programs and advertisements by incorporating such thematic content into product or service advertisements.

In one embodiment of the invention, the advertisements incorporate program-advancing elements of the program, such as characters, objects, sounds, settings, dialogue relating to a program theme, and any other aspect of a program that can be recognized in an advertisement. The advertisement containing thematic content may be shown or viewed in between segments of the program, before or after the showing or viewing of the program.

The method and system of the present invention can be computer-implemented, such as with production equipment and in an automated fashion using computer software. The equipment and/or software recognizes the product/service-related content of an advertisement and inserts a program's thematic content into the advertisement. In some instances, the inserted thematic content may be computer-generated, obviating the need to film or photograph such content. Alternatively, the production equipment allows for the filming or photographing of the product advertisement along with characters and/or other elements of a program in the advertisement.

It is to be understood that both the foregoing general description and the following detailed description are exemplary, but are not restrictive, of the invention.

### BRIEF DESCRIPTION OF DRAWINGS

The following detailed description of the invention will be better understood when read in conjunction with the appended drawings. It should be understood, however, that the invention is not limited to the precise arrangement shown, but rather it is defined by the claims appended hereto and equivalent structures.

FIG. 1 is a diagram of the method and system of the present invention.

### DETAILED DESCRIPTION OF THE INVENTION

The present invention comprises a method and system for incorporating thematic content (audio and/or video and/or print media) from a particular program into the content of product or service advertisements, i.e., audio and/or video and/or print media about the product or service. The program may be a television program, a movie, a printed publication, computer software, an alternate reality game (also known in the art as an alternative reality game) (“ARG”) or Internet-based game. The program may be one from (and this is a non-exhaustive list) a non-pay network, a cable network, a satellite network, a book, a magazine, a comic book or comic strip, a novel, any other printed work, the Internet, a video game and other computer software, or a program broadcast through any alternative medium, including, but not limited to, computer networks, such as the Internet, movie theaters and pre-recorded videos. The thematic content comprises program-advancing elements of the program, such as characters, objects, sounds, settings, dialogue relating to a program theme, any other element capable of being recognized, or any combination of such elements. The program-advancing elements are capable of being recognized by their association with a program and/or by their association with other program-advancing elements, even if the program-advancing element was not previously included in the program. The program-integrated advertisement comprises audio, video and/or printed work containing an element of the program along with audio, video and/or printed work which advertises a product or service.

When used in association with motion picture films, thematic content from a film can be incorporated into a product or service advertisement. The plot of a film can be advanced by using a medium of advertisements that are not movie trailers. If a film is replayed on television, the program-integrated advertisement associated with it may be shown during a commercial break. Program-integrated advertisements associated with a film may be used to expand plot points or aspects of specific characters that would not otherwise be addressed in the film. For films that are part of a series, program-integrated advertisements could act similarly to how they may act in relation to a television show; they could provide foreshadowing about what will occur in the next film in the series, or elucidation of what has already occurred. For multiple part movies or television shows that are recorded on video or other alternative mediums, the program integrated advertisement(s) can appear during, before and/or after each movie part or television program.

Program-integrated advertisements may also be used in print advertising. The plot of a program could be advanced using any kind of print advertisement for a product or service. Plot-advancing elements could appear within print advertisements or within or on the products themselves. Non-limiting examples of print advertisements include: a product advertisement on a billboard that also contains a plot-advancing element from a program; a clue word relating to the plot of a program appearing under the cap of a soda bottle; and one or a series of magazine or newspaper advertisements for a particular product that contains a plot-advancing element or plot-advancing elements from a program. The advertisement or series of advertisements form an event or sequence of events that advances the plot of the show.

A program-advancing element is anything that promotes a program, and/or supplements or uses some existing element of the program to impact any aspect of the program, e.g., the story line. A program-advancing element is a plot-advancing element if it impacts the program and/or a program-promoting element if it promotes the program. The program-advancing element is specific to a program or is associated with a program element such that it is capable of being recognized by a viewer. This includes, but is not limited to, character actions, setting description, objects, sound recognition, and character dialogue, etc.

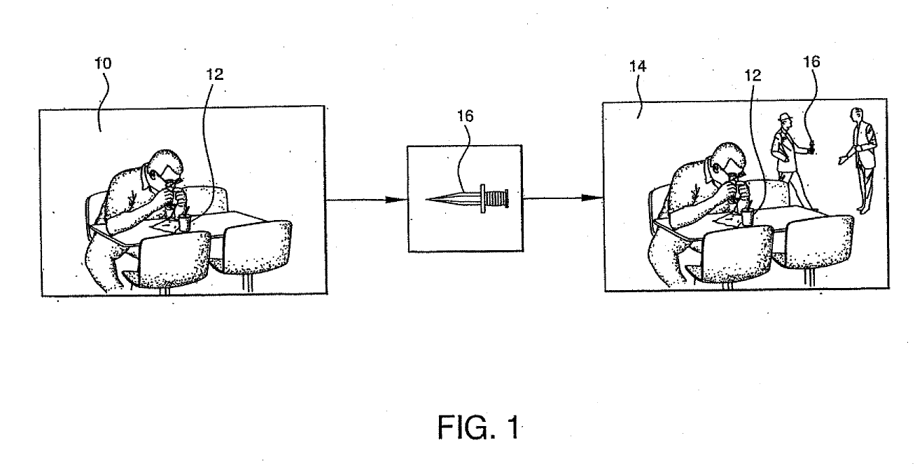

In one embodiment, as shown in FIG. 1, a conventional advertisement 10, shown or viewed before a television program starts, after a program ends, or during a program's break or intermission, promotes a new product 12 of, for example, a fast-food establishment. The advertisement 10 is attempting to sell the particular product 12. A program-advancing element 16, such as the knife in this particular example, is introduced into the advertisement 10 to form a program-integrated advertisement 14. The program-advancing element relates to the television program and can be a program-promoting element, i.e., a viewer associates the knife with the program. Additionally, the two characters dealing with the knife in the program-integrated advertisement 14 may themselves be program-advancing elements, if they are characters in the program.

The mere appearance of a program element in a product/service advertisement promotes the program and bestows upon that element a magnified significance in relation to the otherwise intact plot line of the given program; such program element is considered program-advancing even if its appearance does not directly contribute to the program's plot. The presence of the program element i.e., program-advancing element causes the advertisement and program to be inextricably linked, as shown in FIG. 1.

Generally, if the program is a television program, the program-integrated advertisements of the present invention are shown or viewed during, before or after the time slot of the television program. When shown or viewed before or after the time slot of the television program, the advertisement may be adjacent to, or any time before or after, the time slot of the television program. In addition, program-integrated advertisements may be included on subsequent audio/visual recordings of a television show or motion picture film. A non-limiting example is the inclusion of program-integrated advertisements on a video, wherein the advertisements contain plot advancing elements of a show. In this scenario, the program-integrated advertisements become part of a package comprising the actual show or film and the program-integrated advertisements associated with that show or film. This package can be presented on released audio/visual recordings after the original episodes have been broadcast or the film played in theaters. In these cases, new program-integrated advertisements may be created strictly for inclusion on the audio/visual recording, or the original program-integrated advertisements may be utilized.

Generally, when the program-integrated advertisements of the present invention are found in print media, the program-integrated advertisements may be shown or viewed in between segments of the program and/or before or after the showing or viewing of the program.

Program-advancing elements according to the present invention are distinguishable from a program's characters (or objects, sounds, settings, dialogue relating to a program theme, etc. to the extent they may have been broadcast previously) featured in advertisements previously shown (such as the Costanzas from the program “Seinfeld” in an MCI long distance telephone service commercial or Bart Simpson from the program “The Simpsons™” in a Butterfinger® candy bar advertisement) by the effect on or the message conveyed by the product or service commercial. If the message conveyed by an advertisement containing a character (or other program element) is at least dual, i.e., (1) it attempts to sell the product or service being advertised, and (2) it attempts to advance the plot of the program and/or promote the program, the character usage is a program-advancing element according to the present invention.

In contrast, when the message conveyed by an advertisement containing a character (or other program element) is singularly to sell the product or service being advertised, that element is not a program-advancing element according to the present invention. The character(s) used in the advertisement may be increasing a viewer's recollection of that advertisement. For example, in the MCI/Costanzas and Butterfinger®/Bart Simpson advertisements, the message conveyed by that advertisement is to promote the product or service being advertised by increasing viewers' recollection of the product/service by associating the product and service with well-known program characters. The message conveyed by the MCI and Butterfinger® advertisements' characters does not advance the plot of or promote their respective programs and, accordingly, the MCI and Butterfinger® advertisements described above would not be considered program-integrated advertisements of the present invention.

A feature of the invention is the obvious or subtle association of a program with any particular product or service advertisement due to the appearance, in the advertisement, of any program-advancing element from the program. The program-advancing element may be a character from the program acting consistent with the way in which that character acts on the program, or any non-character item, such as an object, sound, or setting from the program portrayed in a different light. In addition, a program-advancing element can be an element not previously featured on a program, but which is recognizable based on its association with an existing program element in a program-integrated advertisement according to the present invention. For example, if a character from a program is featured in a program-integrated advertisement with an object never before seen on the program, that object becomes a program-advancing element by its association with that character. The program-integrated advertisement may include part of the program's story line that a viewer would need to watch to obtain full enjoyment of the program.

Furthermore, the invention uses a recognizable element from a program, which can appear in an advertisement in any form. The program and advertisement are associated by time of placement by simply being played on the same network or appearing on the same medium, including, but not limited to, a DVD or video, magazine or newspaper, or are associated by content of the advertisement. The program element can be a replica of one used in the program or a computer-generated image,

If a sponsor would like to make a program-integrated advertisement of the present invention that is not confined to a particular show, movie, publication, ARG, computer software or network, so that it is capable of being played on any network or medium at any time, a “clean” and a “dirty” version of any given advertisement can be made. The “clean” version has no program-advancing elements, and can thus appear on any network or medium at any time. The “dirty” advertisement contains program-advancing elements. Computer software can be used to add or remove such program-advancing elements. With the present state of computer technology, the cost of adding or removing such program-advancing elements would be negligible.

The present invention will diminish the tendency to “channel surf” during advertising time between different television programs or segments of a television program or the tendency to ignore advertisements found in print media. Program-integrated advertisements of the present invention will aid in causing viewers tuned to the network or medium without the possibility of developing an interest elsewhere or on another network or cable channel. With the multitude of cable channels to choose from today and some of them not breaking for advertisements at all, the odds of a viewer returning to the original television program of interest are rapidly decreasing. The same holds true for print advertisements: viewers often ignore advertisements by focusing their attention elsewhere or skipping the advertisements by turning the pages containing the advertisements. Program-integrated advertisements will combat the fickle or disloyal television viewer mentality and will also assist in getting viewers to pay closer attention to advertisements found in print media.

The present invention may be able to remedy an advertiser's inability to retain an advertising slot after the initial airing of the particular episode of a television program. With the program-integrated advertisement, an advertiser might be able to retain an advertising spot even when the program airs again as a rerun on the same network or during syndication years later, possibly on a different network; such advertisement may be the original advertisement or a new, updated advertisement, although incorporating the same program content.

The program-integrated advertisements of the present invention include, but are not limited to, the following types of items: (1) cameo appearances of characters from a program acting in character in a way which relates to the story line (e.g., Cancer Man from “The X-Files,” Mario from Super Mario Brothers or any supporting actors from a particular program); (2) an actual appearance of portions of a program in an advertisement (e.g., a television set playing the program in the background of an advertisement); (3) sweepstakes utilizing a search for a character in a Where's Waldo? vein, in which the advertisement may be interactive (e.g., over the Internet), an instant results sweepstakes which could utilize programs targeted to teenagers (e.g., the WB network, “Saved by the Bell” program, etc.), and/or young kids (e.g., Saturday morning cartoons or other shows); (4) foreshadowing of a program's future plot line, such as with a mystery (e.g., “The X-Files” notebook found in an advertisement having mystery clues) or hype for a program in a new season or new program (e.g., in the “Fedicity” program, missing character (Noel) is seen in an advertisement before his character is found on the program to give an indication of where he may or may not be found during the program);

(5) expansion of a program's plot line, where actual events take place in the advertisements that did not take place in the program (e.g., the passing of a knife from one villain to another in the back of a Wendy's® advertisement, similar to the passing of the knife in FIG. 1); (6) sound bytes both on and off camera (e.g., “Seinfeld's” George and Elaine acting in character and arguing during an advertisement); (7) an Internet site to access information on a program or contest (e.g., a connection to a “Seinfeld” site where contestants compete in real time); and/or (8) streaming audio and video on an Internet web site having program elements in advertisements.

Incorporation of a theme into an advertisement can be used subtly, for example, as part of the advertisement language. Specifically, program-advancing elements can be incorporated into advertisements by filming or photocopying such elements while the advertising content is being filmed or created; by inserting such elements, taken from the program and/or filmed separately, into an existing advertisement by various editing techniques known in the art; by computer manipulation of such elements and the advertising content; or any combination of these techniques.

The program-integrated advertisement can be shown at a specific (or confined) time and/or place for viewing. In addition, the advertisement can be intermittently shown to reinforce behavior. In an exemplary embodiment, about two (or other appropriate number between about 1 and 10 depending on the program) minutes of a television program's time can be reserved for program-integrated advertisement.

Advertisements incorporating thematic content can be shown in various media, including, but not limited to, television, radio, Internet, video and print media. In addition, the present invention also includes using program-integrated advertisements from a medium other than non-pay television, cable, satellite network, magazines, newspapers and billboards, such as computer networks (e.g., the Internet), or any other medium intended for or consistent with the purposes described herein.

The method of the present invention can help to ensure that viewers view advertisements during breaks in the program being viewed, which is virtually unprecedented; this can increase the revenue television networks, movie producers and publishers collect for advertising and increase the public exposure that an advertiser's product or service receives.

Further, one example of handling the issue of airtime and syndication is for companies who run advertising containing program elements to purchase show time. In other words, about two (or other appropriate number between about 1 and 10 depending on the program) minutes of actual showtime would be sold, on top of the regular commercial slots. This would be a premium cost slot because of the memory factor (the audience would associate the program-advancing element with the name of the company) and about 3 or 4 commercials could be sold for each 2-minute slot.

Production equipment allows for the creation of advertising content and thematic content from a program and insertion/incorporation into a program-integrated advertisement. The method and system of the present invention may be computer-implemented such that computer software controlling production equipment allows for the development of advertisements containing program-advancing elements from a program. The software monitors the content of the advertisement; alternatively, the software can create the content of the advertisement. When the advertisements contain audio and video, the software controls the insertion of the audio and video feed, which comprise the thematic content from a program, into an advertisement; additionally, the software may generate the audio and video feed prior to insertion. The computer-implemented method and system allow for precise matching of advertisements with thematic content so as to achieve the highest viewership.

The following non-limiting examples help to illustrate the present invention.

### EXAMPLE 1

An example of the method and system of the present invention utilizes a television program of “The Prisoner.” In the program, the character who is the prisoner on an island is pictured in a scene along with a woman wearing an orange dress who is a resident of the island and a nemesis of the prisoner. In a product advertisement for Canadian fiberglass insulation airing in between segments of the program, the woman in the orange dress is placed in a scene of the advertisement, standing in front of a specific house. The woman in the orange dress comprises a program-advancing element because the advertisement provides an indication of the activities and location of the woman in the orange dress which advances the program's plot. Viewers are more likely to watch this type of advertisement for aspects of “The Prisoner” program.

### EXAMPLE 2

In another example of the present invention, a character in the program finds a notebook with some cryptic writing in it, and it becomes a key element in the program. That notebook, acting as a program-advancing element, could turn up during an advertisement break, for example, in a Wendy's® advertisement being read by a patron at a table as the camera passes As such, the program-integrated advertisement can be simple and non-intrusive in inserting elements of the program into the advertisements,

### EXAMPLE 3

In yet another example of the present invention, two shady-looking characters enter the story line of a particular program at different times and are not yet known to have any connection to one another. In an automobile advertisement, the same two characters appear in the background conversing in a conspiratorial manner. This apparent conspiracy advances the plot by portraying the shady-looking characters in a new light. The characters and apparent conspiracy are acting as program-advancing elements. This is in contrast to the use of well-known characters from a television program acting in character in an advertisement, such as the Costanzas in the MCI commercial, to hype the product/service being advertised. In the example of the present invention, the characters are used to advance the program's plot and to promote the program; in conventional advertisements, such as the MCI commercial described above, the recognition of that the program's characters provides an association which helps to sell the product/service.

### EXAMPLE 4

In still another example of the present invention, foreshadowing can be used. A grandfather clock, acting as a program-advancing element, appears in a Coke advertisement in a conspicuous manner. In a later program of which Coke is a sponsor, that same grandfather clock appears as a prominent clue in a murder case. Again, the initial Coke advertisement advanced the plot of the program by providing foreshadowing to a particular object that later becomes relevant to the program.

### EXAMPLE 5

In a further example of the present invention, Cancer Man from the program “The X-Files” appears in the back of a crowd holding an important folder in a Pepsi advertisement. Cancer Man holding the folder is acting as a program-advancing element. If Cancer Man appeared in the advertisement without the folder or any reference to the plot line, he would still be acting as a program-advancing element because of the increased focus on his character caused by the advertisement and the message conveyed by such an advertisement would be dual; the advertisement would be promoting sales of the product being advertised, and advancing the plot of and/or promoting the program.

### EXAMPLE 6

In an example of a program-advancing element comprising sound recognition or dialogue relating to a program theme, characters sitting around the table in a Kraft® Macaroni and Cheese advertisement make reference to a particular character's plight in the program “The Practice.”

### EXAMPLE 7

In an another example of a program-advancing element comprising sound recognition or dialogue relating to a program theme, an intercom of a Wendy's® in a Wendy's® fast food restaurant advertisement broadcasts the voice of a character from the program “The West Wing,” mentioning a detail or clue relating to the program.

### EXAMPLE 8

In yet a further example of the present invention, foreshadowing is again used. A billboard, magazine or newspaper advertisement for school notebooks contains Ron Weasley passing a note to Draco Malfoy in class while Harry Potter and Hermione Granger are watching Professor Minerva McGonagall (all are characters from Harry Potter®). The apparent conspiracy advances the plot by portraying Ron Weasley in a new light, i.e., before the advertisement Ron Weasley was not known to associate with Draco Malfoy. The characters and apparent conspiracy are acting as program-advancing elements.

### EXAMPLE 9

In still yet another example of the present invention, elucidation of the plot of an Internet-based ARG occurs. An ARG typically leads participants through a plot based on a series of clues that appear both online and in everyday life. An important aspect of a particular ARG is to go to actual locations to obtain clues. These clues will be incorporated with content on an Internet site to allow players to solve a mystery, such as a mystery related to a document outlining the rites of an ancient secret society. In a television advertisement taking place in a Burger King® restaurant, a particular street address is embedded in the lighted menu above the counter. This address relates to a location that is of vital importance to the continuation of the plot of the ARG. Players would know to look for the address because either the time of broadcast or something related to Burger King® was indicated on the Internet site.

In Examples 1-9, the program-advancing elements may also be considered program-promoting elements because the appearance of the elements promotes the program.

Although illustrated and described above with reference to certain specific embodiments, the present invention is nevertheless not intended to be limited to the details shown. Rather, the present invention is directed to a method and system of incorporating the thematic content of programs into advertisements, and various modifications may be made in the details within the scope and range of equivalents of the description and without departing from the spirit of the invention.

1-27. (canceled)

28. A method of advertising comprising:
using a program-integrated advertisement to promote a program and a product or service wherein:
the program-integrated advertisement comprises product or service advertising content and a plot-advancing element for a program,
the product or service advertising content promotes the product or service, respectively,
the plot-advancing element promotes a plan or pattern of events or a storyline of the program, and
the product or service differs from the program.

29. The method of claim 28, further comprising showing or viewing the program-integrated advertisement between segments of the program, before or after showing or viewing the program.

30. The method of claim 28, wherein the plot-advancing element is at least one member selected from the group consisting of characters, objects, sounds, settings, and dialogue relating to a program theme.

31. The method of claim 28, wherein the plot-advancing element is a character from the program.

32. The method of claim 28, wherein using the program-integrated advertisement further comprises showing or viewing the program-integrated advertisement in at least one medium selected from the group consisting of television, radio, Internet, video and print media.

33. The method of claim 28, wherein the program is a television program and the program-integrated product or service advertisement is broadcast during or adjacent to a time slot of the program.

34. The method of claim 28, wherein the plot-advancing element is selected from the group consisting of a cameo appearance of a character from the program, a portion of the program, an item foreshadowing a plot of the program, an item expanding the plot of the program, language from the program, and the character from the program.

35. The method of claim 28, wherein the plot-advancing element is a program-promoting element.

36. The method of claim 28, wherein the program is a television program, a movie, a printed publication, computer software, an alternate reality game or an Internet-based game.

37. The method of claim 28, wherein the program is shown or viewed in at least one medium selected from the group consisting of non-pay network, cable network, satellite network, book, magazine, comic book, comic strip, novel, Internet, video game, movie theater and pre-recorded video.

38. A method of incorporating thematic content from a program into an advertisement comprising:
combining the thematic content from the program and product or service content to form a program-integrated advertisement, wherein
the thematic content comprises plot-advancing content, the plot-advancing content promotes a plan or pattern of events or a storyline of the program, and
the program differs from the product or service.

39. The method of claim 38, wherein the plot-advancing content is at least one member selected from the group consisting of characters, objects, sounds, settings, and dialogue relating to a program theme.

40. The method of claim 38, wherein the combining step is computer-implemented.

41. The method of claim 40, wherein the computer-implementation is performed with computer software.

42. The method of claim 38, wherein the program-integrated advertisement is shown or viewed in at least one medium selected from the group consisting of television, radio, Internet, video and print media.

43. The method of claim 38, wherein the program is a television program and the program-integrated product or service advertisement is capable of being broadcast during or adjacent to a time slot of the program.

44. The method of claim 38, wherein the plot-advancing content is a program-promoting element.

45. The method of claim 38, wherein the program is a television program, a movie, a printed publication, computer software, an alternate reality game or an Internet-based game.

46. The method of claim 38, wherein the program is capable of being shown or viewed in at least one medium selected from the group consisting of non-pay network, cable network, satellite network, book, magazine, comic book, comic strip, novel, Internet, video game, movie theater and pre-recorded video.

47. A method of increasing viewership of a program, a product or service advertisement, or both, comprising:
using a program-integrated advertisement to promote a program and a product or service wherein:
the program-integrated advertisement comprises product or service advertising content and a plot-advancing element for a program,
the product or service advertising content promotes the product or service, respectively,
the plot-advancing element promotes a plan or pattern of events or a storyline of the program,
the product or service differs from the program; and
showing or viewing the program-integrated product or service advertisement in between segments of the program, before or after showing or viewing the program.

48. A method of producing an advertisement with thematic content from a program, comprising:
generating advertising content for a product or service, wherein the product or service differs from the program;
assigning a plot-advancing element from the program to the advertising content to form a program-integrated advertisement, the plot-advancing element comprising at least one member selected from the group consisting of characters, objects, sounds, settings, and dialogue relating to a program theme, wherein:
the program-integrated advertisement is capable of being shown or viewed in at least one medium selected from the group consisting of television, radio, Internet, video and print media;
the program-integrated product or service advertisement is capable of being shown or viewed in between segments of the program, before or after showing or viewing the program; and
the plot-advancing element promotes a plan or pattern of events or a storyline of the program.

49. A system for incorporating thematic content from a program into a program-integrated advertisement, comprising:
plot-advancing thematic content from the program;
advertising content for a product or service, wherein the product or service differs from the program; and
production equipment for combining the advertising content and the thematic content to form the program-integrated advertisement, wherein the program-integrated advertisement is capable of being shown or viewed in between segments of the program, before or after showing or viewing the program, and the plot-advancing thematic content promotes a plan or pattern of events or a storyline of the program.

50. The system of claim 49, wherein the plot-advancing thematic content is at least one member selected from the group consisting of characters, objects, sounds, settings, and dialogue relating to a program theme.

51. The system of claim 49, wherein the production equipment for combining the advertising content and the thematic content is computer-implemented.

52. The system of claim 51, further comprising computer software for computer-implementation.

53. The system of claim 49, wherein the program-integrated advertisement is capable of being shown or viewed in at least one medium selected from the group consisting of television, radio, Internet, video and print media.

54. The system of claim 49, wherein the plot-advancing thematic content is selected from the group consisting of a cameo appearance of a character from the program, a portion of the program, an item foreshadowing a plot of the program, an item expanding the plot of the program, language from the program, and the character from the program.

55. The system of claim 49, wherein the program is a television program, a movie, a printed publication, computer software, an alternate reality game or an Internet-based game.

56. The system of claim 49, wherein the program is capable of being shown or viewed in at least one medium selected from the group consisting of non-pay network, cable network, satellite network, book, magazine, comic book, comic strip, novel, Internet, video game, movie theater and pre-recorded video.

57. A program-integrated advertisement comprising:
thematic content comprising a plot-advancing element of a program, wherein the plot-advancing element promotes a plan or pattern of events or a storyline of the program; and
product or service content, wherein the product or service differs from the program.

58. The program-integrated advertisement of claim 57, wherein the plot-advancing element is at least one member selected from the group consisting of characters, objects, sounds, settings, and dialogue relating to a program theme.

59. The program-integrated advertisement of claim 57, wherein the plot-advancing element is a character from the program.

60. The program-integrated advertisement of claim 57, wherein the program-integrated advertisement is capable of being shown or viewed in at least one medium selected from the group consisting of television, radio, Internet, video and print media.

61. The program-integrated advertisement of claim 57, wherein the program is a television program and the program-integrated product or service advertisement is capable of being broadcast during or adjacent to a time slot of the program.

62. The program-integrated advertisement of claim 57, wherein the plot-advancing element is selected from the group consisting of a cameo appearance of a character from the program, a portion of the program, an item foreshadowing a plot of the program, an item expanding the plot of the program, language from the program, and the character from the program.

63. The program-integrated advertisement of claim 57, wherein the plot-advancing element is a program-promoting element.

64. The program-integrated advertisement of claim 57, wherein the program is a television program, a movie, a printed publication, computer software, an alternate reality game or an Internet-based game.

65. The program-integrated advertisement of claim 57, wherein the program is capable of being shown or viewed in at least one medium selected from the group consisting of non-pay network, cable network, satellite network, book, magazine, comic book, comic strip, novel, Internet, video game, movie theater and pre-recorded video.

66. A system for creating a program-integrated advertisement comprising:
advertising content for a product or service;
a plot-advancing element from a program;
a mechanism for assigning the plot-advancing element from the program to the advertising content, wherein
the plot-advancing element promotes a plan or pattern of events or a storyline of the program, and
the program differs from the product or service.

67. The system of claim 66, wherein the mechanism for assigning the plot-advancing element from the program to the advertising content comprises production equipment.

68. The system of claim 66, wherein the program-integrated advertisement is capable of being shown or viewed in between segments of the program, before or after showing or viewing the program.

69. The system of claim 66, wherein the plot-advancing element is at least one member selected from the group consisting of characters, objects, sounds, settings, and dialogue relating to a program theme.

70. The system of claim 66, wherein the mechanism for assigning the plot-advancing element from the program to the advertising content is computer-implemented.

71. The system of claim 70, further comprising computer software for computer-implementation.

72. The system of claim 66, wherein the program-integrated advertisement is capable of being shown or viewed in at least one medium selected from the group consisting of television, radio, Internet, video and print media.

73. The system of claim 66, wherein the plot-advancing element is selected from the group consisting of a cameo appearance of a character from the program, a portion of the program, an item foreshadowing a plot of the program, an item expanding the plot of the program, language from the program, and the character from the program.

74. The system of claim 66, wherein the program is a television program, a movie, a printed publication, computer software, an alternate reality game or an Internet-based game.

75. The system of claim 66, wherein the program is capable of being shown or viewed in at least one medium selected from the group consisting of non-pay network, cable network, satellite network, book, magazine, comic book, comic strip, novel, Internet, video game, movie theater and pre-recorded video.
